(19) United States
(12) Patent Application Publication
(10) Pub. No.: US 2020/0364724 A1
(43) Pub. Date: Nov. 19, 2020

(54) SYSTEMS AND METHODS FOR AUTOMATED WHISPER COACHING

(71) Applicant: Cisco Technology, Inc., San Jose, CA (US)

(72) Inventors: Srinivasa Subramanyam Pulugurtha, Nashua, NH (US); Sajith Gopal Kaimal, Stow, MA (US)

(73) Assignee: Cisco Technology, Inc., San Jose, CA (US)

(21) Appl. No.: 16/414,590

(22) Filed: May 16, 2019

(51) Int. Cl. G06Q 30/00; G06Q 30/02; G06N 20/00; H04L 12/58

(52) U.S. Cl. CPC G06Q 30/016; H04L 51/02; G06N 20/00; G06Q 30/0281

(57) ABSTRACT

Automated whisper coaching for a Customer Service Representative (CSR), engaged in a customer service interaction with a customer, is provided. First, a customer service interaction session, at a contact center server, between the CSR and the customer begins. A first data stream from a CSR computer to a customer computer is sent. A second data stream from the customer computer is received. The first data stream and the second data stream are analyzed by a supervisor BOT. Based on the analysis, the supervisor BOT provides automated whisper coaching to the CSR computer.

### TECHNICAL FIELD

The present disclosure relates generally to communications applications executing between two parties.

### BACKGROUND

In a customer service interaction, for example a customer communicating with a representative of an organization, a customer service representative desires to provide helpful information or guidance. The customer service representative, thus, should be well-trained to understand the customer's needs and respond appropriately. While training before an interaction is valuable, training during an interaction is also valuable. Thus, learning from a supervisor, as the customer interactions occur, can improve the training to the customer service representative.

### BRIEF DESCRIPTION OF THE FIGURES

The accompanying drawings, which are incorporated in and constitute a part of this disclosure, illustrate various embodiments of the present disclosure. In the drawings:

FIG. 1 shows an operating environment for training and directing a customer service representative in accordance with aspects of the present disclosure;

FIG. 2 shows an example of a customer service application in accordance with aspects of the present disclosure;

FIG. 3A shows an example user interface content that may be shown on a customer display device in accordance with aspects of the present disclosure;

FIG. 3B shows an example user interface content that may be shown on a customer service representative and/or supervisor device in accordance with aspects of the present disclosure;

FIG. 4 shows a signaling diagram in accordance with aspects of the present disclosure;

FIG. 5A shows a data structure stored, sent, received, or retrieved to provide training and/or direction to a customer service representative in accordance with aspects of the present disclosure;

FIG. 5B shows a data structure stored, sent, received, or retrieved to provide training and/or direction to a customer service representative in accordance with aspects of the present disclosure;

FIG. 5C shows a data structure stored, sent, received, or retrieved to provide training and/or direction to a customer service representative in accordance with aspects of the present disclosure;

FIG. 6 shows a method, conducted by the customer service application, to train a BOT in accordance with aspects of the present disclosure;

FIG. 7 shows a method, conducted by the customer service application, to execute a BOT in accordance with aspects of the present disclosure;

FIG. 8 shows a block diagram of a computer or computing device for conducting or executing the methods and processes for classifying content in a customer service interaction in accordance with aspects of the present disclosure.

### DETAILED DESCRIPTION

Overview

Automated whisper coaching for a Customer Service Representative (CSR), engaged in a customer service interaction with a customer, is provided. First, a customer service interaction session, at a contact center server, between the CSR and the customer begins. A first data stream from a CSR computer to a customer computer is sent. A second data stream from the customer computer is received. The first data stream and the second data stream are analyzed by a supervisor BOT. Based on the analysis, the supervisor BOT provides automated whisper coaching to the CSR computer.

Both the foregoing overview and the following example embodiments are examples and explanatory only, and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Supervisors can have a great impact on the success of customer care centers. However, supervisors are often hired in limited numbers, and their time is very valuable and expensive. In many customer care centers, a supervisor spends time on training new hires, supporting team members during difficult customer conversations, manage Customer Service Representative (CSR) growth and career progression.

Contact center systems can allow a supervisor or the person managing the CSRs to train them during a live customer conversation. The training conversation is not audible to the customer. This type of supervision is referred to as whisper coaching. Whisper coaching can help with training and evaluating CSRs. Supervisors typically whisper coach during calls or contacts to help CSRs. If a supervisor is not available to whisper coach, then either the CSR may make the customer wait or the quality of service can suffer.

A contact center can store historical records of whisper coaching transcripts and recordings, which may represent thousands of hours of stored content. Often times, the interaction history is embodied in single media channel (for example, voice, chat, etc.). Using the stored whisper coaching content, the customer service application can train and autonomous program (referred to as a robot or BOT) that can become an automated whisper coach. The BOT can learn from one or more channels (e.g. voice records, chat transcripts, etc.) and may apply the learned behavior to other channels.

Thus, the systems and methods herein can create and employ a Whisper Coacher BOT that learns from previous coaching sessions between human supervisors and CSRs. The BOT, once trained, can provide whisper coaching in subsequent customer interactions across multiple media channels. The BOT can augment/automate the whisper coaching function.

Contact centers can store recording or interaction data with additional metadata that can identify if whisper coaching is contained in a recording. Audio recordings that contain whisper coaching can be converted to text. The various speakers can be annotated within the speech transcript. During training, the Artificial Intelligence (AI) algorithm of the whisper coaching BOT can learn from the transcripts (and other information) and associated metadata (e.g., call records). Outcome of the interaction can be part of the metadata. If the outcome is not part of the metadata, the BOT may glean the outcome from the transcript (which may be analyzed for sentiment).

Once the training is complete, the BOT may be deployed when a CSR requests help in an interaction with a customer or automatically. Based on the ongoing interaction's textual transcript, the BOT can generate suggestions either in the form of a next-best-action or phrase sequence. Dialogue and monologue transcripts can be used to train various AI models. Further, the training materials from different media channels can be used to train the BOT. Interactions can be different between voice and chat channels, and the BOT can compensate for the differences. Regardless, there can be common knowledge and skill used in the supervisory function in different media channels. Since whispered suggestions are concise, relayed during silence, the whisper coaching input can be well-suited for cross channel training. Additionally, voice channel specific suggestions can be detected using existing frameworks and excluded from the cross channel training materials. Thus, the BOT can be trained on common, topic/content driven text/content that can provide supervision across channels.

An actual implementation of a Whisper Coacher Bot for voice channel may look at both common and channel specific suggestions. The methods, systems, etc. herein focus on cross-channel functionality. Advantages of the aspects presented herein can include one or more of, but is not limited to, improvements to resource utilization (e.g., saving valuable supervisor's time), reductions in costs by automating or augmenting the supervisory function, improvements to service consistency that eliminates customers waiting for a supervisor, regardless of when the customer decides to contact the customer care center, and maintains response quality, even without a supervisor present.

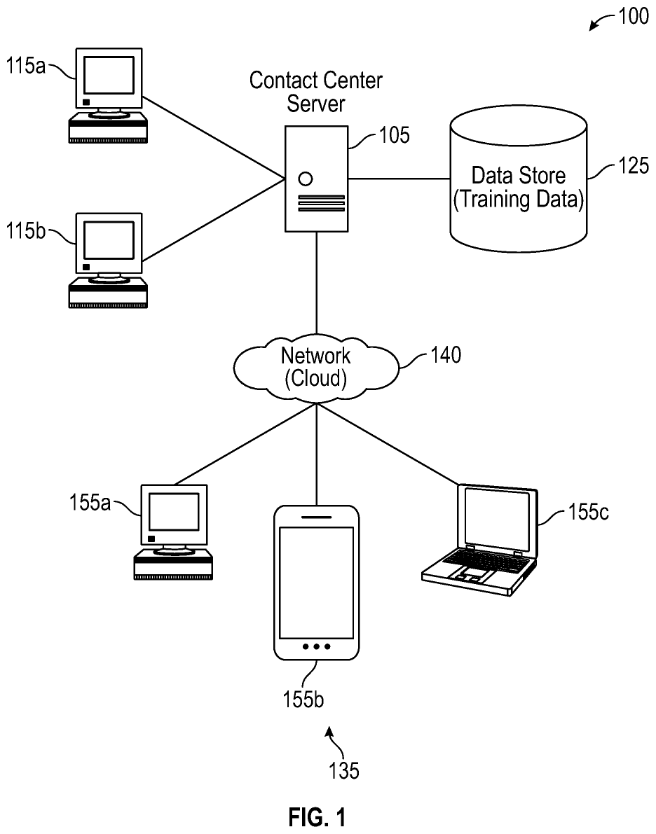

FIG. 1 shows an operating environment 100 for training and deploying an autonomous program (e.g., a BOT) in a customer contact system that interacts with a customer. The customer interaction, through video, chat, audio, or some other media, can include communications sent between a CSR computing system 115 and a customer computing system 155. As shown in FIG. 1, operating environment 100 may comprise a contact center server 105 and a network 140. The contact center server 105 can receive data streams from the various customer devices 155a-155c in the customer service interaction and forward these data streams for provision on the users' computers 155, the CSR computer 115a, and/or the supervisor computer 115b. It should be noted that the data stream may be provided in any media, video, voice, chat, etc., and provided to the computing systems 115, 155 or other device. Thus, the computing systems 115, 155 can represent any device capable of providing the media type to the CSR, supervisor, and/or customer, for example, a computer, a telephone, a mobile device, a video display, etc. Further, the data streams may be processed by and passed through the contact center server 105.

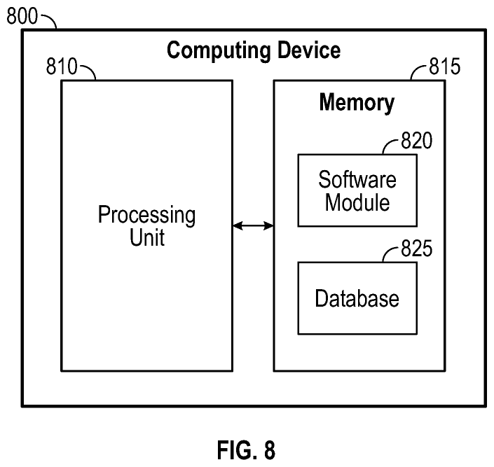

Further, the contact center server 105 may collect information about the data streams, associated with a customer service interaction, and sent from one or more CSR, supervisor, and/or user computing systems 115 and/or 155, in a group of devices 135, involved in the customer service interaction. This information can be stored in the data store 125 to train a BOT, as described in more detail below. The contact center server 105 can provide information about the content in the data stream to train the BOT. The information can be used, by the BOT, to determine how to provide whisper coaching to a CSR during a customer service interaction. The BOT may execute on the contact center server 105 and/or on the computing systems 115. The Contact center server 105 may be located inside or outside network 140, for example, in a cloud environment. The contact center server 105 can be any hardware and/or software, as described in conjunction with FIG. 8.

The data stream(s) may be sent through one or more networks, represented by network 140. Network 140 may comprise, but is not limited to, an enterprise network and/or an outside network that may comprise an enterprise's communications backbone, the Internet, another Local Area Network (LAN), a Wide Area Network (WAN), or other network that may connect computers and related devices across departments and interconnect the CSR 115a, supervisor 115b, contact center server 105, and/or customer 155, facilitating the sharing of information in a customer service interaction. A network 140 may comprise a router, an access point, a user device (e.g., device 155), or other components or systems.

A plurality of end user devices 135 may be connected to one or more of the devices in the network 140, which allows for multiple customer service interactions to be conducted with the contact center server 105 contemporaneously. The network 140 can comprise any hardware device or configured node on a LAN, WAN, or other network that allows a device to connect through a communication standard. Network devices 140 can feature a processor, radio transmitters, and antennae, which facilitate connectivity between devices 155, 115, 105, and the network 140. The network devices 140 can be as described in conjunction with FIG. 8.

User devices 155 may comprise, but are not limited to, a cellular base station, a tablet device, a mobile device, a smartphone, a telephone, a remote control device, a set-top box, a digital video recorder, a cable modem, a personal computer, a network computer, a mainframe, a router, or other similar microcomputer-based device capable of accessing and using network 140. The user devices 155 can be any hardware and/or software, as described in conjunction with FIG. 8.

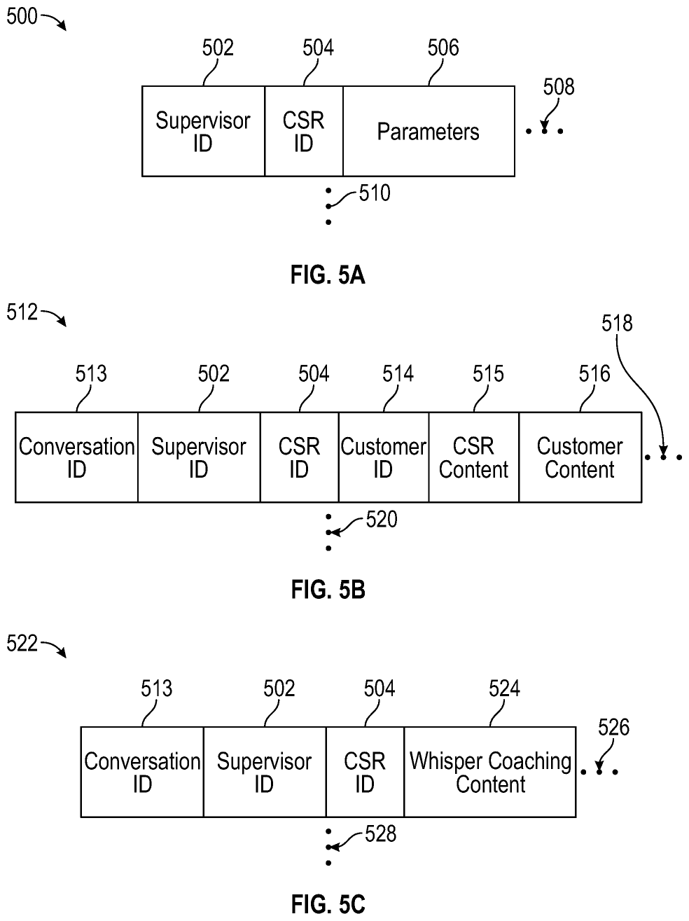

The data store 125 can be any type of data store, database, file system, and/or memory or storage. The data store 125 can store, manage, retrieve, etc. data associated with a customer service interaction. The data store 125 may be hardware and/or software associated with the contact center server 105 or associated with another separate system as described in conjunction with FIG. 8. Regardless, the data store 125 may include at least a portion of the data described in conjunction with FIGS. 5A, 5B, and/or 5C.

The elements described above of operating environment 100 (e.g., contact center server 105, the computing systems 115, the data store 125, end user device 155, etc.) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 8, the elements of operating environment 100 may be practiced in a computing device 800.

Consistent with embodiments of the disclosure, the user device 155 may be in communication over the network 140 to the contact center server 105 to send or receive a data stream associated with a customer service interaction. The contact center server 105 can receive the data streams from two or more devices 155, 115 during the customer service interaction. To provide automated supervision of the CSR during the customer service interaction, the contact center server 105 can execute a BOT that can provide automated whisper coaching to the CSR, without the customer hearing, viewing, and/or perceiving the inputs, during the customer service interaction. Hereinafter, provided in greater detail below, the processes of training the BOT before and executing the BOT during the customer service interaction are further described.

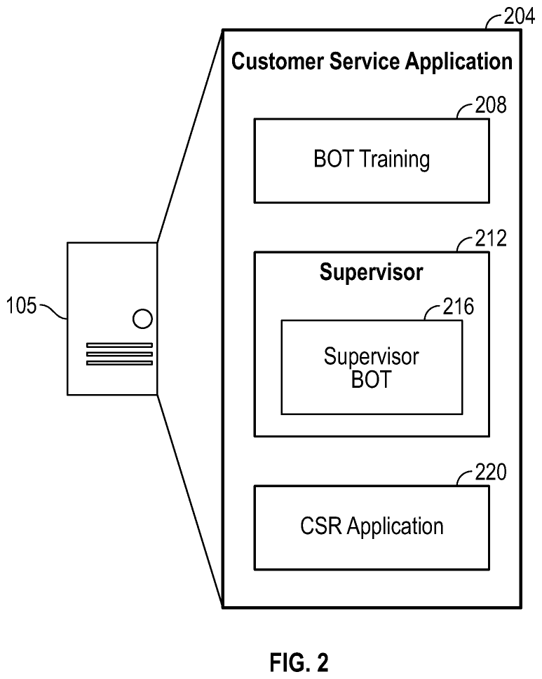

An exemplary contact center server 105 may be as shown in FIG. 2. The contact center server 105 can include at least a customer service application 204. The customer service application 204 can be any software and/or hardware that provides the customer service interaction. Thus, the customer service application 204 can mix the various data streams provided from the two or more devices 155, 115 involved in the customer service interaction and send the mixed signal to the two or more devices 155, 115. Thus, the customer service application 204 manages numerous inbound and outbound data streams. In at least some configurations, the customer service application 204 can include or execute a BOT that performs automated whisper coaching during the customer service interaction. Thus, the customer service application 204 can include one or more of, but is not limited to, a BOT training application 208, a supervisor application 212, which can include the supervisor BOT 216, and/or a CSR application 220.

The BOT training application 208 can analyze the stored data streams, as possibly stored in data store 125, from two or more devices 155, 115 involved in the customer service interaction, when that customer service interaction included whisper coaching. This analysis can include characterizing the content of the data streams based on the characteristics of the exchange between the CSR, supervisor, and customer, characterizing the sentiment of the exchange, analyzing the metadata associated with the interaction, etc. Based on this analysis, the BOT training application 208 can train a machine learning model on different types of whisper coaching input, the content of the whisper coaching input, the appropriate time to interject whisper coaching input, etc. It should be noted that the BOT training application 208 can analyze data streams of one of more various media types, e.g., chat, voice, video, etc., to train the supervisor BOT 216. Hereinafter, the process of training the supervisor BOT, with the BOT training application 208, to provide whisper coaching will be described in more detail.

The supervisor application 212 provides the supervisor, of the CSR, with the ability to receive the data streams in the customer service interaction and accept input from the supervisor to the CSR during the customer service interaction. The supervisor application 212 can receive the data stream(s) in the customer service interaction and may display or output the data stream as provided hereinafter. Further, the supervisor application 212 can also accept inputs from the supervisor, for example, whisper coaching inputs. The inputs can be inserted into the data stream for the CSR computer 115a, but can exclude the customer computer 155 data stream. Thus, the whisper coaching inputs are provided only to the CSR. Part of the supervisor application 212 may be automated by the supervisor BOT 216, which can also review the incoming data stream and provide automatic or automated responses thereto, with or without assent from the supervisor.

The supervisor BOT 216 can analyze the stored data streams, from the two or more devices 155, 115 involved in the customer service interaction, in the customer service interaction. This analysis can include characterizing the content of the present data streams based on the characteristics of the exchange between the CSR, supervisor, and customer, characterizing the sentiment of the exchange, analyzing the metadata associated with the interaction, etc. Based on this analysis, the supervisor BOT 216 can apply a machine learning model to generate automated whisper coaching input. The whisper coaching input can be input to the CSR computer 115a, the supervisor computer 115b, but not the customer computer 155. This whisper coaching input may also be made in any type of media stream, e.g., audio, chat, etc. The whisper coaching input is also automated and need not receive authorization from a supervisor to send or generate the input.

The CSR application 220 provides to the CSR computer 115a, and in some configurations, to the customer computer 155 the data stream in the customer service interaction and receives any input from the CSR during the customer service interaction. The CSR application 220 can receive the data stream in the customer service interaction and may display or output the data stream as provided hereinafter. Further, the CSR application 220 can also accept inputs from the CSR, for example, responses or messages to the customer. The inputs can be inserted into the data stream for the supervisor computer 115b and the customer computer 155 data stream. Any whisper coaching inputs can also be provided by the CSR application 220 to the CSR.

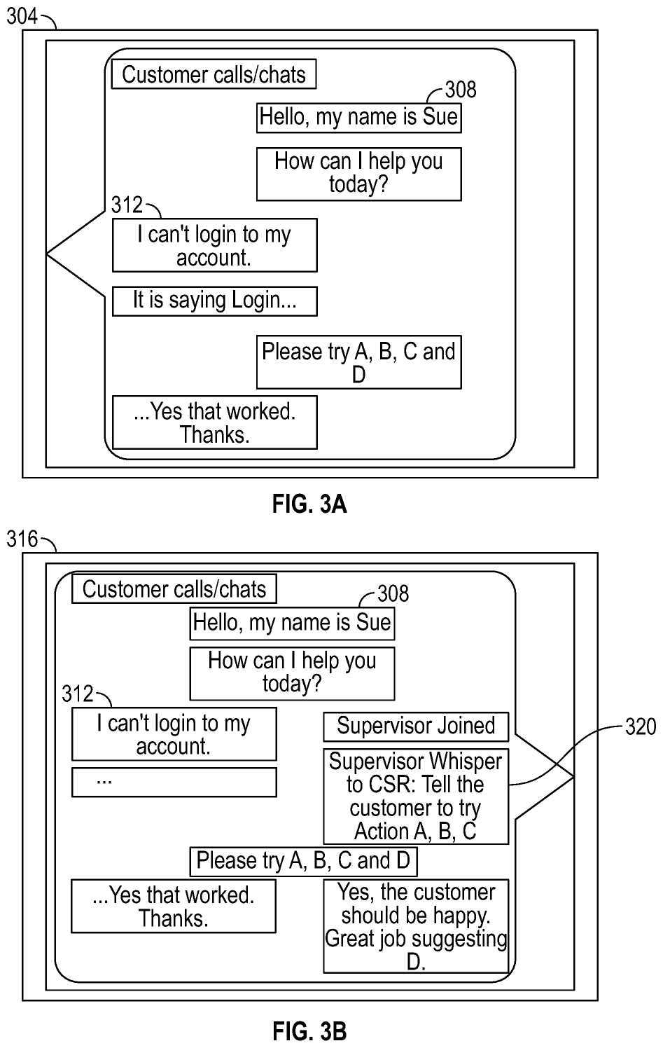

An example of a user interface 304, for a customer computer 155, provided during one type of customer service interaction, and the concomitant data associated therewith, may be as shown in FIG. 3A. The user interface display 304 can be a customer screen which represents at least a display or output of the user device 155. In the display 304, the customer's view of the customer service interaction may include text data or another presentation of the CSR inputs 308. Further, in display 304, the customer's view of the customer service interaction may also include text data or another presentation of the customer's own inputs 312. It should be noted that the user interface 304 represents a customer service interaction as a chat session. However, the customer service interaction can be completed through other media types, e.g., audio, video, etc., and that the user interface 304 is just one example of a type of customer service interaction. Thus, the data within the user interface 304 can also represent video, audio, or other multimedia data. Further, it should be noted that the customer's view or perception of the customer service interaction does not include any whisper coaching that may occur on the CSR computer 115a, as noted in FIG. 3B. In other words, the whisper coaching is silent or imperceptible with respect to the customer's side 304 of the customer service interaction.

An example of another user interface 316 may be as shown in FIG. 3B. The user interface 316 can be a user interface display on the CSR computer 115a and/or the supervisor computer 115b. The user interface display 316 can be a CSR and/or supervisor screen which represents at least a display or output of the computing systems 115. In the display 316, the CSR's and/or supervisor's view of the customer service interaction may include text data or other presentation of the CSR inputs 308 and the customer's inputs 312. It should be noted that the user interface 304 represents a customer service interaction as a chat session. However, the customer service interaction can be completed through other media types, e.g., audio, video, etc., and that the user interface 316 is just a representation of a type of customer service interaction. Thus, the data within the user interface 316 can represent video, audio, or other multimedia data.

Further, the user interface 316 can also include the whisper coaching input 320. The whisper coaching inputs 320 can be input by the supervisor and/or the supervisor BOT 216. Regardless of the source of the whisper coaching, the whisper coaching input 320 can be shown on the CSR computing system 115a and/or the supervisor computing system 115b. Further, the transcript of the customer service interaction, as may be shown in FIG. 3B, may also be used by the BOT training application 208 to train the supervisor BOT 216. It should be noted that the whisper coaching inputs 320 shown on the display 316 are not shown or received on the customer's side 304 of the customer service interaction. Thus, the customer service application 204 prevents the whisper coaching input 320 from being sent to the customer 155.

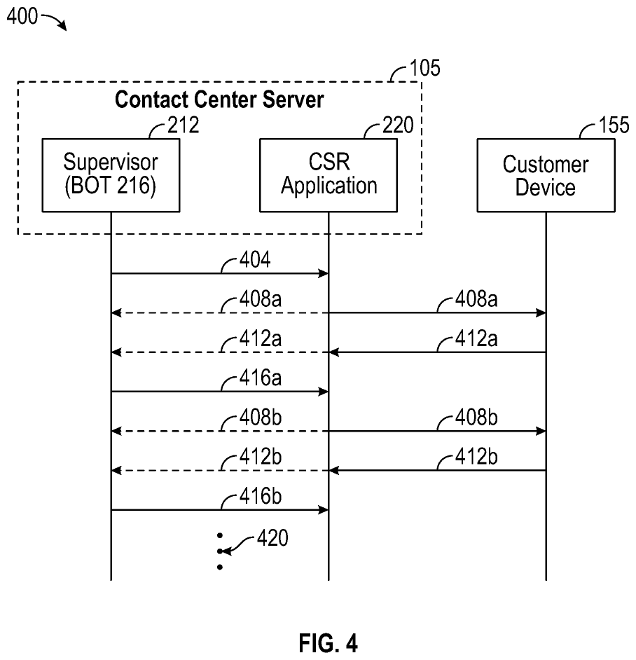

FIG. 4 is a signalling diagram 400 that shows a least some of the communications between the user device 155 and the contact center server 105. The signals may be sent in various stages to provide the customer service interaction and to provide whisper coaching, local to the contact center server 105. A supervisor application 212 can connect with and join with a CSR application 220, in signal 404. In response to signal 404, interactions between the CSR application 220 and any customer 155 may be monitored by the supervisor application 212.

Thereinafter, a CSR application 220 may send a first communication to a customer, in signal 408a. This signal 408a may also be relayed to the supervisor application 212. A user device 155 can send a reply or other input, in signal 412a. This reply signal 412a can also be relayed to the supervisor application 212. Based on the interactions in at least one or more of signals 408 and 412, a supervisor BOT 216 can provide automatic whisper coaching, in signal 416a, to the CSR application 220. The signal 416a stays in the contact center server 105 and is not relayed to the customer device 155. Another exchange of messages may occur in signals 408b, 412b, and/or 416b. These interactions may repeat more or fewer times than that shown in FIG. 4, as represented by ellipses 420.

FIG. 5A is a data structure 500 that may be an example of the data included in signal 404. The data structure 500 can include one or more of, but is not limited to, a supervisor Identifier (ID) 502, a CSR ID 504, and/or parameters 506. The data structure 500 can include more or fewer fields than those shown in FIG. 5A, as represented by ellipses 508. Further, each CSR computer 155a, managed or supervised by the supervisor computer 115b, involved in a customer service interaction, can receive a data structure 500. Thus, there may be more data structures provided in the environment 100 than that shown in FIG. 5A, as represented by ellipses 510, based on the number of CSR computers 115a operating with the contact center server 105 and the supervisor computer 115b.

The supervisor ID 502 can represent any type of identifier that uniquely identifies the supervisor application 212 and/or supervisor computer 115b. Thus, the supervisor ID 502 can be a numeric ID, and alphanumeric ID, an Internet Protocol (IP) address, a Media Access Control (MAC) address, or some other address or ID used by the contact center server 105 to the send signal 404 to the CSR computer 115a and/or CSR application 220 and to recognize which supervisor computer 115b or supervisor application 212 is associated with the data stream.

The CSR ID 504 can represent any type of identifier that uniquely identifies the CSR computer 155a and/or CSR application 220 in the customer service interaction. Thus, the CSR ID 504 can be a numeric ID, and alphanumeric ID, an IP address, a MAC address, a phone number, or some other address or ID used by the contact center server 105 to identify the CSR computer 155a and/or CSR application 220 for conducting the customer service interaction associated with the data stream from the CSR computer 155a and/or CSR application 220 sent to the customer computer 155 from contact center server 105.

The parameters 506 can include any data, associated with the customer service interaction, sent between the supervisor application 212 and/or supervisor computer 115b and the CSR computer 155a and/or CSR application 220. Thus, the parameters 506 can include settings, media types, types of customer service interactions allowed, how to display or provide content or whisper coaching, connection ports, etc. that represents how and what is being shared between the supervisor application 212 and/or supervisor computer 115b and the CSR computer 155a and/or CSR application 220. The parameters 506 may be classified by the supervisor application 212 and/or the customer service application 204 based on the requirements of the customer service interactions.

Further, the parameters 506 can indicate how a supervisor BOT 216 will interact with the CSR computer 155a and/or CSR application 220. For example, the parameters 506 can indicate if the CSR computer 155a and/or CSR application 220 can receive automated whisper coaching, whether the BOT 216 will provide all or a some of the whisper coaching, whether the supervisor application 212 and/or supervisor computer 115b executes a supervisor BOT 216, the format or output characteristics of the whisper coaching, etc. Thus, the parameters 506 can indicate the conditions and environment for the automated whisper coaching.

FIG. 5B is another data structure 512 that may be an example of the data included in signal 408 and/or signal 412. The data structure 512 can include one or more of, but is not limited to, a conversation ID 513, the supervisor ID 502, the CSR ID 504, a customer ID 514, CSR content 515, and/or customer content 516. The data structure 512 can include more or fewer fields than those shown in FIG. 5B, as represented by ellipses 518. Further, each device 155, 115, involved in a customer service interaction, can send several data structures 512 during a customer service interaction, and thus, there may be more data structures provided than that shown in FIG. 5B, as represented by ellipses 520. The supervisor ID 502 and the CSR ID 504 may be as previously described with data structure 500, and thus, will not be explained further. It should be noted that the data structure 512 may represent data as provided in a chat session or other text-based customer service interaction. However, the data with data structure 512 may have similar or the same types of data (although in a different format or provided differently) with other media types, e.g., audio or video, that may also be represented by data structure 512.

The conversation ID 513 can represent any type of identifier that uniquely identifies the customer service interaction. Thus, the conversation ID 513 can be a numeric ID, and alphanumeric ID, any type other identifier (e.g., IP address, MAC address, phone number, etc.) associated with the customer service interaction, or some other address or ID used by the contact center server 105 to identify the customer service interaction. The conversation ID 513 can identify the customer service interaction and the associated data streams during the customer service interaction and after the data stream content and metadata is stored in data store 125. Using the conversation ID 513, the contact center server 105 can properly receive and send the data streams, in the customer service interaction, between the customer computer 155, the supervisor application 212 and/or supervisor computer 115b, and/or the CSR computer 155a and/or CSR application 220.

The customer ID 514 can represent any type of identifier that uniquely identifies the customer or customer computer 155 in the customer service interaction. Thus, the customer ID 514 can be a numeric ID, and alphanumeric ID, an IP address, a MAC address, a name, a username, a phone number, or some other address or ID used by the contact center server 105 to identify the customer or customer computer 155. The customer ID 514 can identify the customer for conducting the customer service interaction associated with the data stream from the customer computer 155 sent to the contact center server 105 and vice versa.

The data structure 512, if representing signal 408, can include CSR content 515 generated from the CSR computer 155a and/or CSR application 220 and provided to the user device 155 involved in the customer service interaction. The CSR content 515 can include any type of content (e.g., chat inputs, voice responses or input, video input, multimedia input, etc.) sent from the CSR to the customer. Thus, the CSR content 515 can include the audio, video, text, multimedia, etc. being shared between the CSR computer 155a and/or CSR application 220 and the customer computer 155 in the data signal 408. The CSR content 515 may be generated by the CSR with the CSR computer 155a and/or CSR application 220. Further, the CSR content 515 can also be shared with the supervisor application 212 and/or supervisor computer 115b, including the supervisor BOT 216.

The data structure 512, if representing signal 512, can include customer content 516 received from the user device 155 involved in the customer service interaction. Thus, the customer content 516 can also include the audio, video, text, multimedia, etc. being shared between the customer computer 155 and the CSR computer 155a and/or CSR application 220 in data signal 412. The customer content 516 may be generated by the customer computer 155 for the CSR computer 155a and/or CSR application 220. Further, the customer content 516 can also be shared with the supervisor application 212 and/or supervisor computer 115b, including the supervisor BOT 216.

FIG. 5C is another data structure 522 that may be an example of the whisper coaching data included in signal 416. The data structure 522 can include one or more of, but is not limited to, the conversation ID 513, the supervisor ID 502, the CSR ID 504, and/or, whisper coaching content 524. The data structure 522 can include more or fewer fields than those shown in FIG. 5C, as represented by ellipses 526. Further, each customer service interaction, supervised by the supervisor application 212 and/or supervisor computer 115b, including the supervisor BOT 216, can send a data structure 522, and thus, there may be more data structures provided in environment 100 by the contact center server 105 than that shown in FIG. 5C, as represented by ellipses 528. The conversation ID 513, the supervisor ID 502, and the CSR ID 504 may be as previously described with data structure 500 and/or data structure 512, and thus, will not be explained further.

The whisper coaching content 524 can include content automatically generated from the supervisor BOT 216 (and/or input by a human supervisor) and provided to the CSR computer 155a and/or CSR application 220 involved in the customer service interaction. The whisper coaching content 524 is includes any type of content (e.g., chat inputs, voice inputs, video inputs, multimedia inputs, etc.) sent from the supervisor BOT 216 to the CSR computer 155a and/or CSR application 220. Thus, the whisper coaching content 524 can include the audio, video, text, multimedia, etc. being shared between the supervisor BOT 216 and the CSR computer 155a and/or CSR application 220 in the data signal 416. The whisper coaching content 524 may be automatically generated by the supervisor BOT 216, without input from the human supervisor. Further, the whisper coaching content 524 can also be shared with the supervisor application 212 and/or supervisor computer 115b, for display on the supervisor computer 115b, if the human supervisor is also monitoring the customer service interaction.

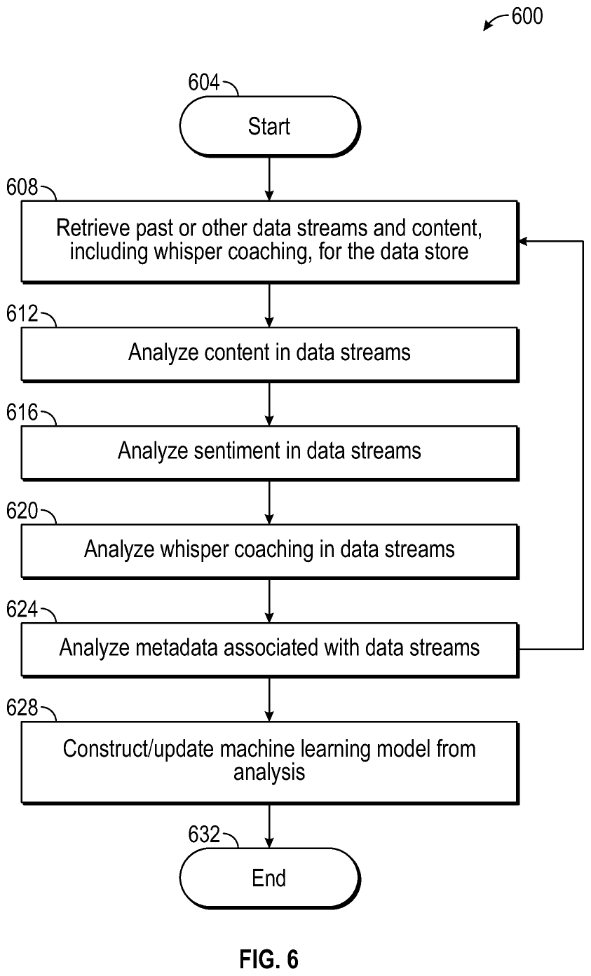

An embodiment of a method 600, as conducted by the BOT training application 208, for training the supervisor BOT 216, may be as shown in FIG. 6. A general order for the stages of the method 600 is shown in FIG. 6. Generally, the method 600 starts with a start operation 604 and ends with an end operation 632. The method 600 can include more or fewer stages or can arrange the order of the stages differently than those shown in FIG. 6. The method 600 can be executed as a set of computer-executable instructions executed by a computer system and encoded or stored on a computer readable medium. Further, the method 600 can be performed by gates or circuits associated with a processor, an Application Specific Integrated Circuit (ASIC), a Field Programmable Gate Array (FPGA), a System-On-Chip (SOC), or other hardware device. Hereinafter, the method 600 shall be explained with reference to the systems, components, devices, modules, software, data structures, data characteristic representations, signalling diagrams, methods, etc. described in conjunction with FIGS. 1-5C and 7-8.

The BOT training application 208, of the customer service application 204 executing on the contact center server 105, can retrieve or receive data streams associated with one or more customer service interactions, in stage 608. Thus, the BOT training application 208 can receive data streams, e.g. date structures 512, 522, from customer service interactions occurring contemporaneously with the training. Further, the BOT training application 208 can retrieve data streams, e.g. date structures 512, 522, from the data store 125 of past customer service interactions that were recorded and stored for the training. These data streams can be of different media types, e.g., audio, video, chat, email, social media, etc. While the media type effects how the interaction is conducted, the differing media types are often similar for how whisper coaching is provided, and therefore, the differing media type information is useful in training the supervisor BOT 216.

The data streams analyzed by the BOT training application 208 can include any of the data signals 408-416, as may be represented by data structures 500, 512, and/or 522. Thus, the data can include the content of the customer service interaction and, in at least some configurations, the metadata associated with the data streams, for example, the times of receipt or transmission, the context or subject of the customer service interaction, information about the organization associated with the contact center, the locations of the customer, CSR, or other participants, the names or ratings for the CSR and/or supervisor (e.g., how experienced the parties were), or other information. In other words, the BOT training application 208 retrieves or receives any information needed to properly analyze the information to construct the machine learning model for the supervisor BOT 216. It should be noted that the training may begin with a training data set, but the training of the supervisor BOT 216 can be ongoing as new data can update the machine learning model to make the supervisor BOT 216 more effective.

The BOT training application 208 may then conduct an analysis of the data streams and/or the metadata associated with the data streams, in stages 612-624. Thus, the BOT training application 208 can analyze the CSR content 515, the customer content 516, and/or the whisper coaching content 524 associated with the customer service interactions(s), in stage 612. The words used and the association both temporally and contextually between the messages from the CSR, supervisor, and customer, can be evaluated and linked. Outcomes for the conversation may be determined or analyzed. Other content analysis may be completed. In this way, the BOT training application 208 can determine when and what whisper coaching is required based on words used in the customer service interaction.

The BOT training application 208 can analyze the sentiment of the CSR content 515, the customer content 516, and/or the whisper coaching content 524 associated with the customer service interactions(s), in stage 616. The sentiment analyzes words used that indicate feelings or intent. For example, words such as “great,” “awesome,” “best” can indicate satisfaction, while words such as “terrible,” “unacceptable,” “wrong,” can indicate dissatisfaction. These sentiment words are identified in the content and the association of these sentiments, both temporally and contextually, between the CSR, supervisor, and customer, can be evaluated and linked. The sentiment may be linked to outcomes for the conversation. Other sentiment analysis may be completed. In this way, the BOT training application 208 can determine when and what whisper coaching is required based on the sentiment of the words used in the customer service interaction.

The BOT training application 208 may then conduct an analysis of the whisper coaching associated with the data streams, in stage 620. Thus, the BOT training application 208 can analyze the whisper coaching content 524 associated with the customer service interactions(s). The words used and the association both temporally and contextually, between the CSR, supervisor, and customer interactions, can be evaluated and linked. Outcomes and sentiment for the conversation may be determined or analyzed to determine the effectiveness and timing of the whisper coaching. Other whisper content analysis may be completed. In this way, the BOT training application 208 can determine when and what whisper coaching is required based on the whisper coaching used in the customer service interaction.

The BOT training application 208 may also analyze the metadata associated with the CSR content 515, the customer content 516, and/or the whisper coaching content 524 associated with the customer service interactions(s), in stage 624. The metadata represents other data associated with the data streams. For example, the metadata can include the media type, the date or time when the customer interaction occurred, information about the supervisor or CSR (e.g., the rating of the CSR, the years of experience, customer feedback about the CSR or supervisor, etc.), or other information. This metadata is identified and the association of the metadata with the data streams is evaluated. Then, the metadata can affect the importance or how analysis of one data stream may be more influential than other analysis of other data streams. In this way, the BOT training application 208 can determine the better or best types, content, and/or timing of whisper coaching based on the metadata associated with the customer service interaction.

Thereinafter, the BOT training application 208 can construct or update a machine learning model, in stage 628. Based on the analysis above and/or other analysis, the BOT training application 208 can create/change the machine learning model or algorithms and data used by the supervisor BOT 216 to deliver automated whisper coaching. The machine learning model can be constructed or updated by one or more methods as understood by one skilled in the art. However, this machine learning model evaluates whisper coaching, from a supervisor as interjected into the customer service interaction, without the knowledge of the customer. Thus, the interaction between the customer and CSR is analyzed to determine the effectiveness and timing of the content the whisper coaching, which is not directly provided to the customer. So the machine learning model deals with a unique data set type and environment.

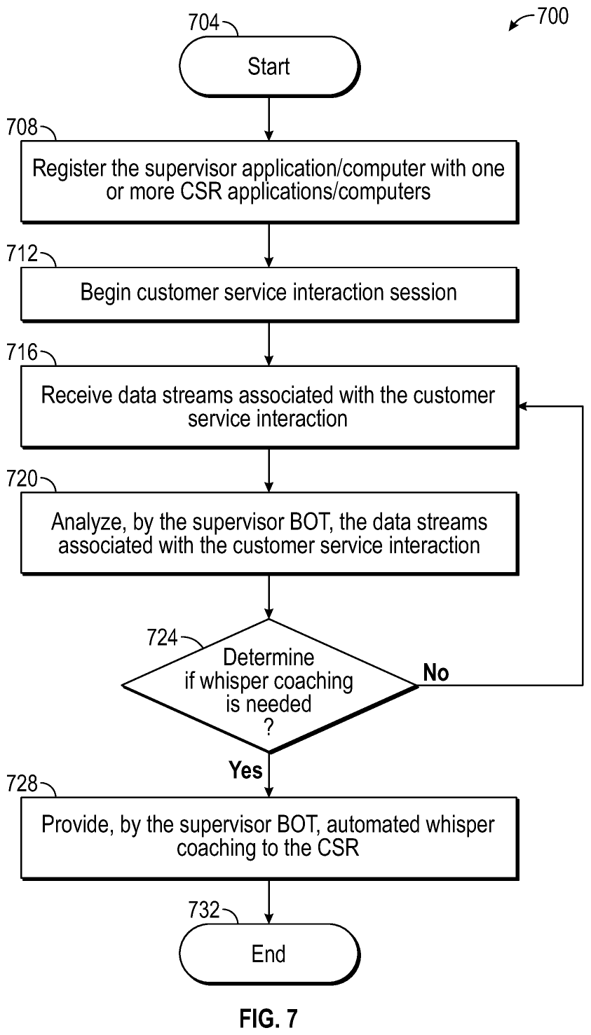

A method 700, as conducted by the supervisor BOT, for automatically providing whisper coaching during a customer service interaction may be as shown in FIG. 7. A general order for the stages of the method 700 is shown in FIG. 7. Generally, the method 700 starts with a start operation 704 and ends with an end operation 732. The method 700 can include more or fewer stages or can arrange the order of the stages differently than those shown in FIG. 7. The method 700 can be executed as a set of computer-executable instructions executed by a computer system and encoded or stored on a computer readable medium. Further, the method 700 can be performed by gates or circuits associated with a processor, an ASIC, a FPGA, a SOC, or other hardware device. Hereinafter, the method 700 shall be explained with reference to the systems, components, devices, modules, software, data structures, data characteristic representations, signalling diagrams, methods, etc. described in conjunction with FIGS. 1-6 and 8.

The supervisor application 212 (and/or the supervisor BOT 216) registers with the CSR application 220 (and/or the CSR computer 115a), in stage 708. The supervisor application 212 and/or the supervisor BOT 216 can send signal 404 including data structure 500. The registration ensures that the customer service application 204 includes the supervisor application 212 and/or the supervisor BOT 216 in any data streams communicated between the CSR application 220 and/or CSR computer 115a and the customer computer 155. Further, the registration allows the supervisor application 212 and/or the supervisor BOT 216 to provide whisper coaching inputs to the CSR application 220 and/or CSR computer 115a without the inputs being viewed or received by the customer 155.

At stage 712, the CSR begins a customer service interaction with a customer 155. Thus, the CSR application 220 and/or CSR computer 115a can send the first signal 408, including some or all of the data in data structure 512, to the customer device 155. The communication may be similar to communication 308, as shown in FIG. 3B. This initial communication can also be provided to the supervisor application 212 and/or the supervisor BOT 216. Thereinafter, the customer may input a response or request into the customer device 155. The customer input may be sent, by the customer device 155, as signal 412, including some or all of the data in data structure 512. This signal 412 may be received by the contact center server 105, in stage 716. The data in data structure 512 may then be presented to the CSR application 220 and/or CSR computer 115a and/or the supervisor application 212 and/or the supervisor BOT 216. Then, the exchange of signals 408 and 412 may repeat as necessary during the customer service interaction.

During the exchange of the signals 408, 412 in the customer service interaction, the supervisor BOT 216 can analyze the data streams, in stage 720. The supervisor BOT 216 can review content, sentiment, metadata, etc. associated with the data streams 408, 412. This review may be similar to what was conducted in method 600 but is completed in real time. Based on the review, the supervisor BOT 216 may determine what, if any, whisper coaching may be needed for the CSR, in stage 724. This determination may be an estimation of sentiment or a comparison to past customer service interactions (as stored in data store 125) that required whisper coaching. Regardless of the method of determining if whisper coaching would be valuable, if whisper coaching is to be made, the method 700 proceeds “YES” to stage 728. However, if whisper coaching is not to be made, the method 700 proceeds “NO” back to stage 716 where more data is received in the data streams and analyzed again.

In stage 728, using the machine learning model algorithm, trained in method 600, the supervisor BOT 216 can equate the present customer service interaction to a similar past interaction(s), stored in data store 125, and extract past whisper coaching that resulted in a positive outcome from the data store 125. The supervisor BOT 216 may then determine the best whisper coaching and provide that whisper coaching. To provide the whisper coaching, the supervisor BOT 216 may convert the whisper coaching into a different media type, e.g., convert text to speech. The whisper coaching may be included in data structure 522. This whisper coaching may then be presented on the CSR computer 115a and the supervisor computer 115b, as described in conjunction with FIG. 3B or [provided in another form or format.

FIG. 8 shows computing device 800. As shown in FIG. 8, computing device 800 may include a processing unit 810 and a memory unit 815. Memory unit 815 may include a software module 820 and a database 825. While executing on processing unit 810, software module 820 may perform, for example, processes for determining content types at an contact center server 105 and sending that information to an online collaboration application at a client to adjust the client's encoding of the data stream, including for example, any one or more of the stages from method 600 or method 700 described above with respect to FIG. 6 and FIG. 7. Computing device 800, for example, may provide an operating environment for elements of operating environment 100 including, but not limited to, contact center server 105, CSR computer 155a, supervisor computer 115b, and user device 155. Elements of operating environment 100 (e.g., contact center server 105, CSR computer 155a, supervisor computer 115b, and user device 155) may operate in other environments and are not limited to computing device 800.

Computing device 800 may be implemented using a Wireless Fidelity (Wi-Fi) access point, a cellular base station, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 800 may comprise any computer operating environment, such as hand-held devices, multiprocessor systems, microprocessor-based or programmable sender electronic devices, minicomputers, mainframe computers, and the like. Computing device 800 may also be practiced in distributed computing environments where tasks are performed by remote processing devices. The aforementioned systems and devices are examples and computing device 800 may comprise other systems or devices.

Accordingly, aspects of the present disclosure comprise a method comprising: beginning a customer service interaction session, at a contact center server, between a Customer Service Representative (CSR) and a customer; providing a first data stream from a CSR computer to a customer computer; receiving a second data stream from the customer computer; analyzing, by a supervisor BOT, the first data stream and the second data stream; and based on the analysis, the supervisor BOT providing automated whisper coaching to the CSR computer.

Any of the one or more above aspects, wherein the whisper coaching is not provided to the customer computer.

Any of the one or more above aspects, wherein the whisper coaching is provided without input from a supervisor.

Any of the one or more above aspects, wherein the supervisor BOT comprises a machine learning model that generates the automated whisper coaching.

Any of the one or more above aspects, wherein the machine learning model is developed from past customer service interaction that include whisper coaching inputs.

Any of the one or more above aspects, wherein the past customer service interactions include two or more media types.

Any of the one or more above aspects, wherein the two or more media types comprise one or more of an audio media type, a video media type, a chat session media type, and/or a social media exchange media type.

Any of the one or more above aspects, wherein the machine learning model is created by a BOT training application, wherein the BOT train application: retrieves past data streams from past customer service interactions; analyzes whisper coaching in the past data streams; based on the analysis, constructs the machine learning model.

Any of the one or more above aspects, wherein the BOT train application further analyzes content in the past data streams, sentiment in the past data streams, and/or metadata associated with the past data streams.

Any of the one or more above aspects, wherein the past data streams comprise two or more media types.

Aspects of the present disclosure further comprise a non-transitory computer readable medium having stored thereon instructions, which when executed by a processor, cause the processor to conduct a method for conducting a customer service interaction with a supervisor BOT, the method comprising: beginning a customer service interaction session, between a Customer Service Representative (CSR) and a customer; providing a first data stream from a CSR computer to a customer computer; receiving a second data stream from the customer computer; analyzing, by the supervisor BOT, the first data stream and the second data stream; and based on the analysis, the supervisor BOT providing automated whisper coaching to the CSR computer.

Any of the one or more above aspects, wherein the whisper coaching is provided without input from a supervisor.

Any of the one or more above aspects, wherein the supervisor BOT comprises a machine learning model that generates the automated whisper coaching, and wherein the machine learning model is developed from past customer service interaction that include whisper coaching inputs.

Any of the one or more above aspects, wherein the past customer service interactions include two or more media types.

Any of the one or more above aspects, wherein the two or more media types comprise one or more of an audio media type, a video media type, a chat session media type, and/or a social media exchange media type.

Aspects of the present disclosure further comprise a system comprising: a memory storage; a processing unit coupled to the memory storage, wherein the processing unit to: execute a customer service application to conduct a customer service interaction between a customer and the system, wherein the customer service application comprising: a supervisor BOT, wherein the supervisor BOT: receives a first data stream from a CSR computer that is sent to a customer computer; receives a second data stream from the customer computer; analyzes the first data stream and the second data stream; and based on the analysis, provides automated whisper coaching to the CSR computer.

Any of the one or more above aspects, wherein the whisper coaching instructs a Customer Service Representative (CSR) on how to respond to the customer.

Any of the one or more above aspects, wherein the supervisor BOT analyzes one or more of analyzes content in the first and/or second data streams, sentiment in the first and/or second data streams, and/or metadata associated with the in the first and/or second data streams.

Any of the one or more above aspects, wherein the customer service application further comprises a BOT training application, wherein the BOT training application: retrieves past data streams from past customer service interactions; analyzes whisper coaching in the past data streams; based on the analysis, trains the supervisor BOT.

Any of the one or more above aspects, wherein the past data streams comprise two or more media types.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a Random Access Memory (RAM), a Read-Only Memory (ROM), an Erasable Programmable Read-Only Memory (EPROM or Flash memory), an optical fiber, and a portable Compact Disc Read-Only Memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' steps or stages may be modified in any manner, including by reordering steps or stages and/or inserting or deleting steps or stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the element illustrated in FIG. 1 may be integrated onto a single integrated circuit. Such a SOC device may include one or more processing units, graphics units, communications units, system virtualization units and various application functionality all of which may be integrated (or “burned”) onto the chip substrate as a single integrated circuit. When operating via a SOC, the functionality described herein with respect to embodiments of the disclosure, may be performed via application-specific logic integrated with other components of computing device 800 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
beginning a customer service interaction session, at a contact center server, between a Customer Service Representative (CSR) and a customer;
providing a first data stream from a CSR computer to a customer computer;
receiving a second data stream from the customer computer;
analyzing, by a supervisor BOT, the first data stream and the second data stream; and
based on the analysis, the supervisor BOT providing automated whisper coaching to the CSR computer.

2. The method of claim 1, wherein the automated whisper coaching is not provided to the customer computer.

3. The method of claim 1, wherein the automated whisper coaching is provided without input from a supervisor.

4. The method of claim 1, wherein the supervisor BOT comprises a machine learning model that generates the automated whisper coaching.

5. The method of claim 4, wherein the machine learning model is developed from past customer service interactions that include whisper coaching inputs.

6. The method of claim 5, wherein the past customer service interactions include two or more media types.

7. The method of claim 6, wherein the two or more media types comprise one or more of an audio media type, a video media type, a chat session media type, and/or a social media exchange media type.

8. The method of claim 4, wherein the machine learning model is created by a BOT training application, wherein the BOT training application:
retrieves past data streams from past customer service interactions;
analyzes whisper coaching in the past data streams;
based on the analysis, constructs the machine learning model.

9. The method of claim 8, wherein the BOT train application further analyzes content in the past data streams, sentiment in the past data streams, and/or metadata associated with the past data streams.

10. The method of claim 9, wherein the past data streams comprise two or more media types.

11. A non-transitory computer readable medium having stored thereon instructions, which when executed by a processor, cause the processor to conduct a method comprising:
beginning a customer service interaction session, between a Customer Service Representative (CSR) and a customer;
providing a first data stream from a CSR computer to a customer computer;
receiving a second data stream from the customer computer;
analyzing, by a supervisor BOT, the first data stream and the second data stream; and
based on the analysis, the supervisor BOT providing automated whisper coaching to the CSR computer.

12. The non-transitory computer readable medium of claim 11, wherein the automated whisper coaching is provided without input from a supervisor.

13. The non-transitory computer readable medium of claim 12, wherein the supervisor BOT comprises a machine learning model that generates the automated whisper coaching, and wherein the machine learning model is developed from past customer service interactions that include whisper coaching inputs.

14. The non-transitory computer readable medium of claim 13, wherein the past customer service interactions include two or more media types.

15. The non-transitory computer readable medium of claim 14, wherein the two or more media types comprise one or more of an audio media type, a video media type, a chat session media type, and/or a social media exchange media type.

16. A system comprising:
a memory storage;
a processing unit coupled to the memory storage, wherein the processing unit to:
execute a customer service application to conduct a customer service interaction between a customer and the system, wherein the customer service application comprising:
a supervisor BOT, wherein the supervisor BOT:
receives a first data stream from a CSR computer that is sent to a customer computer;
receives a second data stream from the customer computer;
analyzes the first data stream and the second data stream; and
based on the analysis, provides automated whisper coaching to the CSR computer.

17. The system of claim 16, wherein the whisper coaching instructs a Customer Service Representative (CSR) on how to respond to the customer.

18. The system of claim 16, wherein the supervisor BOT analyzes one or more of analyzes content in the first and/or second data streams, sentiment in the first and/or second data streams, and/or metadata associated with the in the first and/or second data streams.

19. The system of claim 16, wherein the customer service application further comprises a BOT training application, wherein the BOT training application:
retrieves past data streams from past customer service interactions;
analyzes whisper coaching in the past data streams;
based on the analysis, trains the supervisor BOT.

20. The system of claim 19, wherein the past data streams comprise two or more media types.
